(19) United States
(12) Patent Application Publication
(10) Pub. No.: US 2019/0226813 A1
(43) Pub. Date: Jul. 25, 2019

(54) ALUMINUM/POLYPROPYLENE/ALUMINUM COMPOSITE PANEL ASSEMBLY FOR USE AS A SHIELD

(71) Applicant: Ford Global Technologies, LLC, Dearborn, MI (US)

(72) Inventor: Thomas J. Susko, Saint Clair Shores, MI (US)

(73) Assignee: Ford Global Technologies, LLC, Dearborn, MI (US)

(21) Appl. No.: 15/875,260

(22) Filed: Jan. 19, 2018

(51) Int. Cl. F41H 5/04; B60N 2/68; F41H 5/02

(52) U.S. Cl. CPC F41H 5/0442; B60N 2/686; F41H 5/023; F41H 5/0421; F41H 5/0457

(57) ABSTRACT

A seating assembly includes a seat base. A seatback is operably coupled to the seat base and includes a seat cushion disposed on a front side thereof. A protective panel operably coupled with the seatback panel. The protective panel includes an internal aluminum panel disposed inside the seatback. An external aluminum panel is disposed on the seatback. A polymeric matrix is disposed between the internal aluminum panel and the external aluminum panel.

### FIELD OF THE DISCLOSURE

The present disclosure generally relates to a seating assembly, and more particularly to an aluminum/polypropylene/aluminum composite panel assembly for use as a shield for a seating assembly.

### BACKGROUND OF THE DISCLOSURE

Ballistic resistant panels for use in vehicle seating assemblies can protect people and property from stabbing threats and/or ballistic threats. Traditional panels are often made of materials that are strong, yet very heavy. These heavy panels contribute to lower gas mileage and may have poorer performance when compared to a composite protective panel.

### SUMMARY OF THE DISCLOSURE

According to one aspect of the present disclosure, a seating assembly includes a seat base. A seatback is operably coupled to the seat base and includes a seat cushion disposed on a front side thereof. A protective panel operably coupled with the seatback panel. The protective panel generally defines an anti-stab panel that includes first and second aluminum layers with a polymeric layer disposed therebetween. The protective panel is disposed on an inside wall of the seatback panel.

According to another aspect of the present disclosure, a seating assembly includes a seat base. A seatback is operably coupled to the seat base and includes a seat cushion disposed on a front side thereof. A seatback panel includes a protective panel operably coupled therewith. The protective panel includes an internal aluminum panel disposed inside the seatback. An external aluminum panel is disposed on the seatback. A polymeric matrix is disposed between the internal aluminum panel and the external aluminum panel.

According to yet another aspect of the present disclosure, a seating assembly includes a seat base. A seatback is operably coupled to the seat base. A protective panel operably with an inside surface of the seatback. The protective panel includes an internal panel disposed inside the seatback. An external panel is disposed on the seatback. The internal and external panels are formed from one of a metal and metalloid material. A polymeric matrix is disposed between the internal and external panels.

According to still another aspect of the present disclosure, a seatback for a vehicle seating assembly. A frame includes first and second side frame members. A seatback panel includes a protective panel disposed on a backside of the frame. The protective panel includes an internal panel disposed inside the seatback. An external panel is disposed on the seatback. The internal and external panels are formed from a metalloid material. A polymeric matrix is disposed between the internal and external panels.

Embodiments of the first aspect, the second aspect, and the third aspect of the present disclosure, as set forth in the preceding paragraphs, can include any one or a combination of the following features:
the polymeric matrix includes a reinforcing material disposed therein;
the reinforcing material includes one of glass, Kevlar™, carbon fiber, natural fiber, talc, and mineral fillers;
the polymeric matrix includes glass beads that define an isotactic foam in the polymeric matrix;
the polymeric matrix is comprised of at least one of a high crystalline polypropylene, high density polyethylene, polycarbonate, acrylonitrile-butadiene styrene (ABS), polycarbonate/ABS blends, polymethylmethacrylate, etc.;
the polymeric matrix is heatstaked to each of the internal and external aluminum panels;
the protective panel includes a plurality of apertures to receive fasteners extending from the seatback;
the protective panel includes an offset disposed on at least one side of the protective panel; and the polymeric matrix includes a thickness that is greater than a thickness of the internal panel and a thickness of the external panel.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a front perspective view of a seating assembly of the present disclosure;

FIG. 2 is a side elevational view of a seatback panel of a seating assembly of the present disclosure;

FIG. 3 is a front elevational view of a seatback panel of a seating assembly of the present disclosure;

FIG. 4 is a side cross-sectional view of the seatback panel of FIG. 3 taken at line IV;

FIG. 5 is a bottom cross-sectional view of the seatback panel of FIG. 3 taken at line V;

FIG. 6 is an exploded front perspective view of the seatback panel of FIG. 3;

FIG. 7 is an enlarged top perspective view of the protective panel of FIG. 3;

FIG. 7A is an enlarged perspective view of an embodiment of an internal aluminum panel, an external aluminum panel, and a polymeric matrix of a seating assembly of the present disclosure;

FIG. 8 is a front elevational view of an embodiment of a protective panel of a seating assembly of the present disclosure;

FIG. 9 is a side elevational view of an embodiment of a protective panel of the present disclosure;

FIG. 10 is a side cross-sectional view of the protective panel of FIG. 8 taken at line X-X;

FIG. 11 is a bottom cross-sectional view of the protective panel of FIG. 8 taken at line XI-XI; and

FIG. 12 is an enlarged front elevational view of a corner of a protective panel of the present disclosure.

### DETAILED DESCRIPTION OF THE EMBODIMENTS

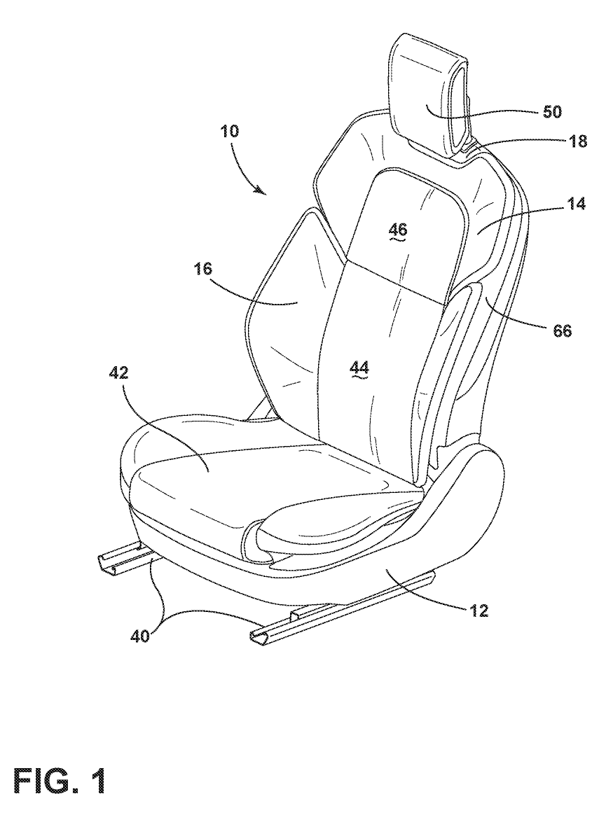

For purposes of description herein, the terms “upper,” “lower,” “right,” “left,” “rear,” “front,” “vertical,” “horizontal,” and derivatives thereof shall relate to the disclosure as oriented in FIG. 1. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

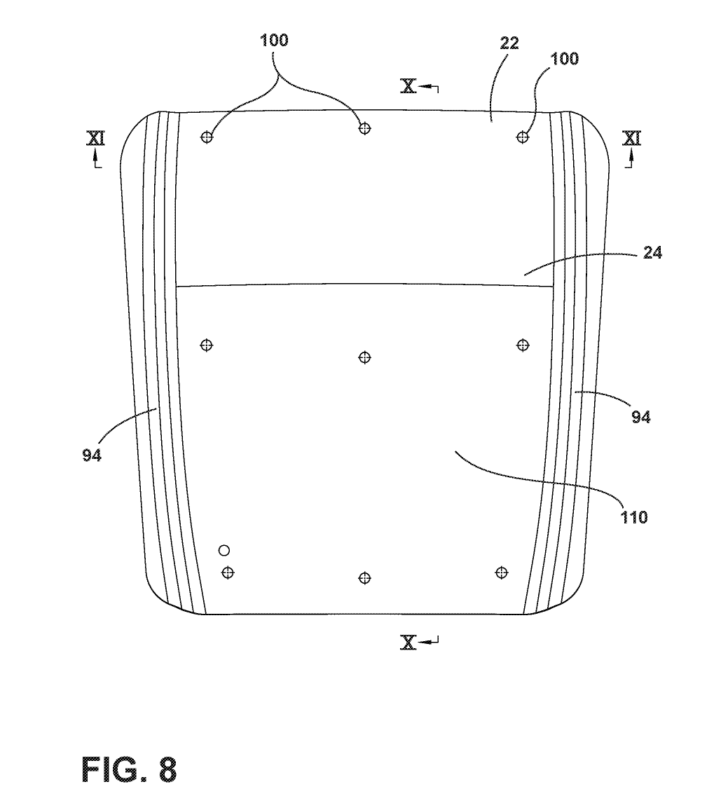

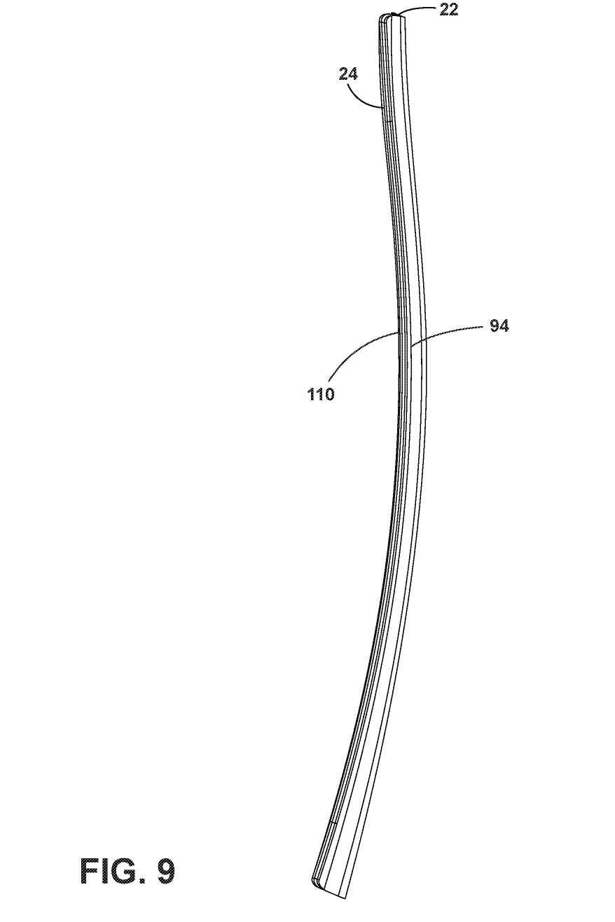

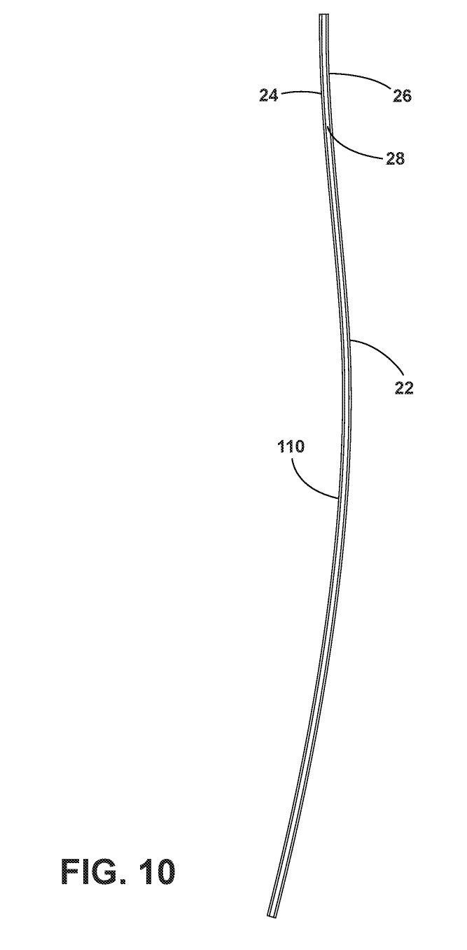

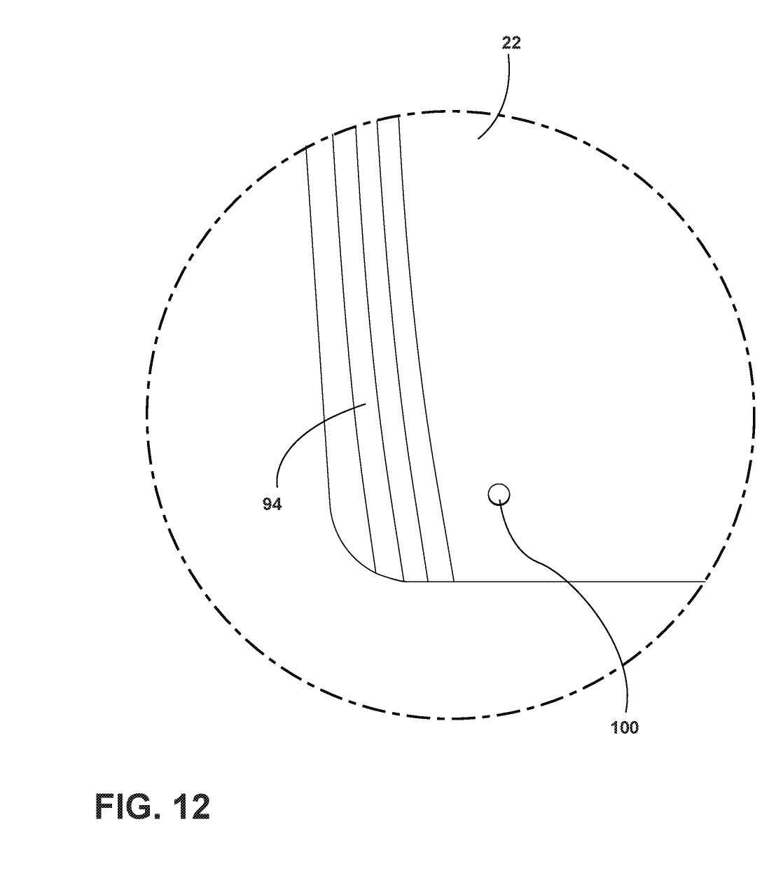

Referring to the embodiment generally illustrated in FIGS. 1-12, reference numeral 10 generally designates a seating assembly that includes a seat base 12. A seatback 14 is operably coupled to the seat base 12 and includes a seat cushion 16 disposed on a front side 18 thereof. A seatback panel 20 includes a protective panel 22 that is operably coupled therewith. The protective panel 22 includes an internal aluminum panel 24 and an external aluminum panel 26 disposed in the seatback 14 and is operably coupled therewith. A polymeric material 28 is disposed between the internal aluminum panel 24 and the external aluminum panel 26.

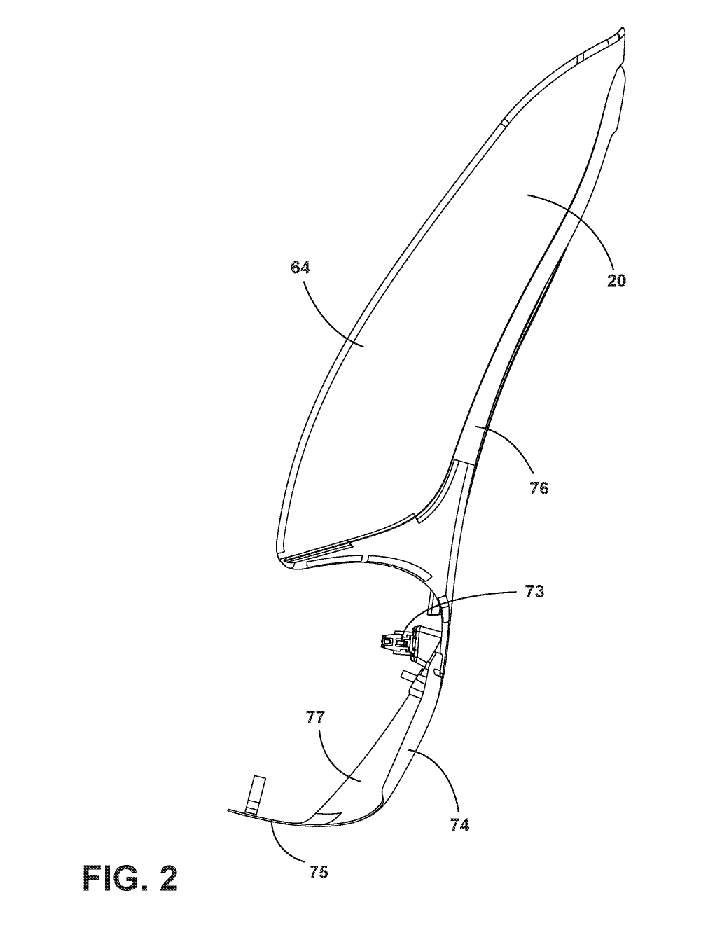

With reference now to FIGS. 1 and 2, the seating assembly 10 may be used in any vehicle, such as a car, a truck, a van, etc. It is also contemplated that the concept set forth in this disclosure may be utilized in a front or forward position of the vehicle as well as a rear or rearward position of the vehicle. The seating assembly 10, as illustrated, includes the seat base 12, which is positioned on rail slides 40 to allow fore and aft movement of the seating assembly 10 relative to the vehicle. A seat 42 is operably coupled with the seat base 12 and is movable relative thereto, as set forth in further detail below. In addition, the seatback 14 of the seating assembly 10 includes a lower lumbar region 44 and an upper thoracic region 46 as well as a head restraint 50. Each of the components of the seatback 14 may be configured for adjustability to properly support the size and weight of various occupants inside the vehicle.

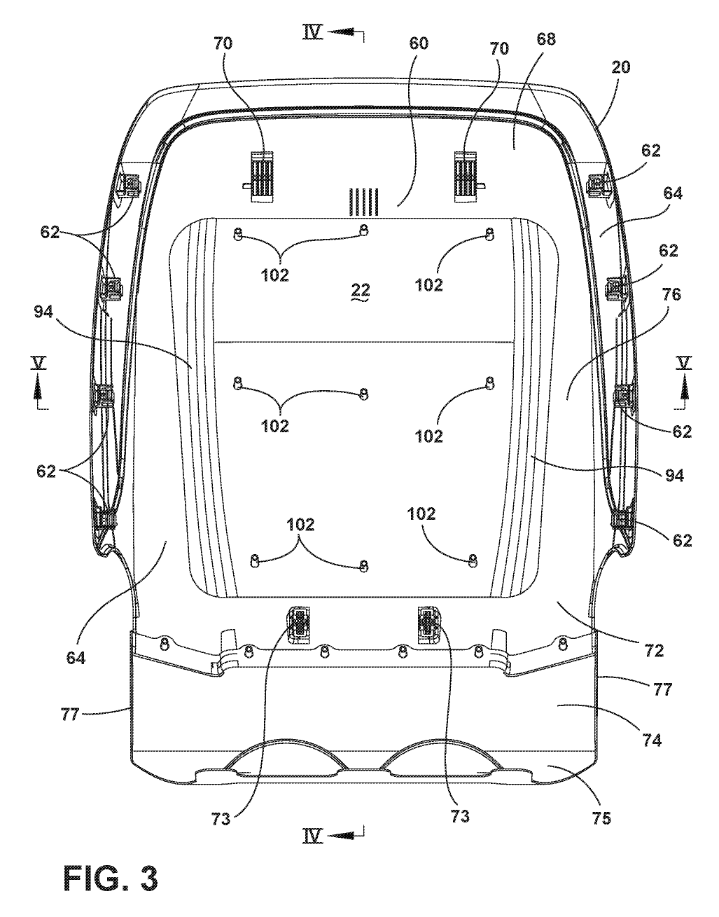

With reference now to FIGS. 2 and 3, the seatback 14 is operably coupled with the seatback panel 20 by way of a variety of clips and hooks disposed on an interior surface 60 of the seatback panel 20. A peripheral piece 64 of the seatback panel 20 includes peripheral clips 62 that are configured to engage a front closeout panel 66 (FIG. 1) of the seating assembly 10. An upper portion 68 of the seatback panel 20 includes hooks 70 that are configured to engage a cross member of a frame of the seating assembly 10. A lower portion 72 of the seatback panel 20 includes clips 73 configured to engage a lower cross member of the frame of the seating assembly 10. A lower closeout panel 74 is disposed below the seatback panel 20 and includes a lower arced portion 75 that arcs inwardly under the seat 42 of the seating assembly 10. In the illustrated embodiment of FIGS. 2 and 3, the lower closeout panel 74 is heatstaked to a main body portion 76 of the seatback panel 20. The lower closeout panel 74 may include side support webs 77 that help support the lower arced portion 75 and conceal an interior of the seating assembly 10. The construction of the seatback panel 20 is generally configured to conceal an interior portion of the seatback 14 and also to provide protection to components disposed within the seatback 14. At the same time, there may be a desire for additional protection in seating assemblies that are used in conjunction with vehicles designed for law enforcement or military purposes. The seatback 14 and the seatback panel 20 are generally constructed from a polymeric material, but may also include cloth, leather, etc. In addition, the seatback panel 20 may include the lower closeout panel 74, the main body portion 76, and the peripheral piece 64 configured for engaging the front closeout panel 66 disposed on the seatback 14 of the seating assembly 10.

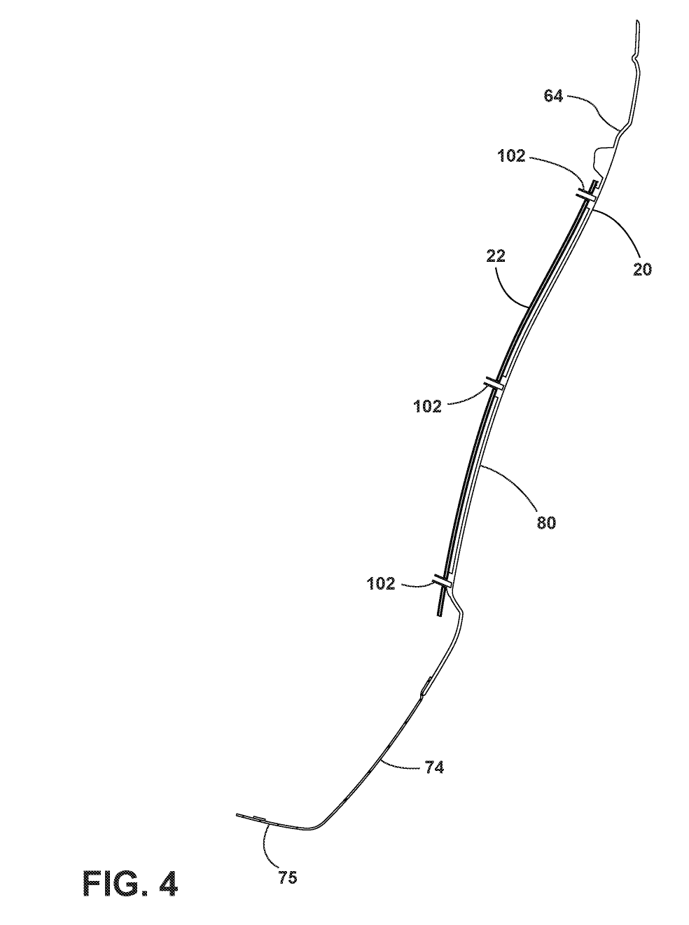

With reference now to FIG. 4, a cross-section of the seatback panel 20 of FIG. 3 is illustrated. As can be seen, the seatback panel 20 includes the protective panel 22, which is disposed in an intermediate portion of the seatback panel 20. The protective panel 22 is configured for attachment on the interior surface 60 of the seatback panel 20 and may be heatstaked, fastened, etc. to the interior surface 60 of the seatback panel 20. It is also contemplated that the protective panel 22 could be disposed on an exterior surface 80 of the seatback panel 20. As can be seen, the lower closeout panel 74 extends below the protective panel 22 near a foot well defined below the seat base 12 of the seating assembly 10.

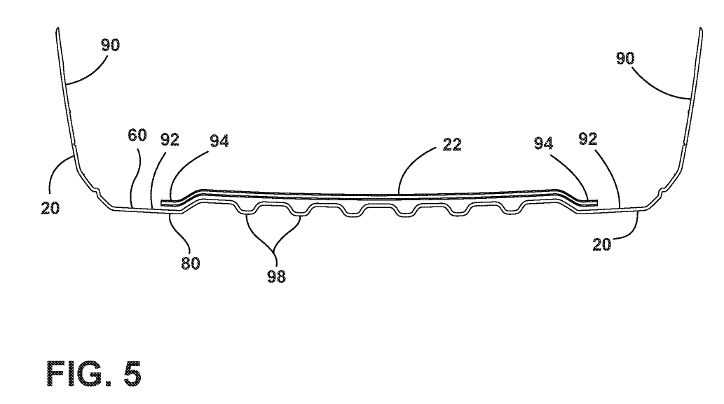

With reference now to FIG. 5, which illustrates a cross-section taken at line V-V of FIG. 3, the protective panel 22 is illustrated in close proximity to the seatback panel 20. Sidewalls 90 of the seatback panel 20 extend forward, while the protective panel 22 is disposed in the intermediate portion of the seatback panel 20. On each side of the seatback panel 20, recesses 92 are configured to receive offsets 94 of the protective panel 22. Prior to securing the protective panel 22 with the interior surface 60 of the seatback panel 20, the interface of the offsets 94 with the recesses 92 may help to locate the protective panel 22 properly on the interior surface 60 of the seatback panel 20. In the illustrated embodiment, there are also a number of undulations 98 disposed at the intermediate portion of the seatback panel 20.

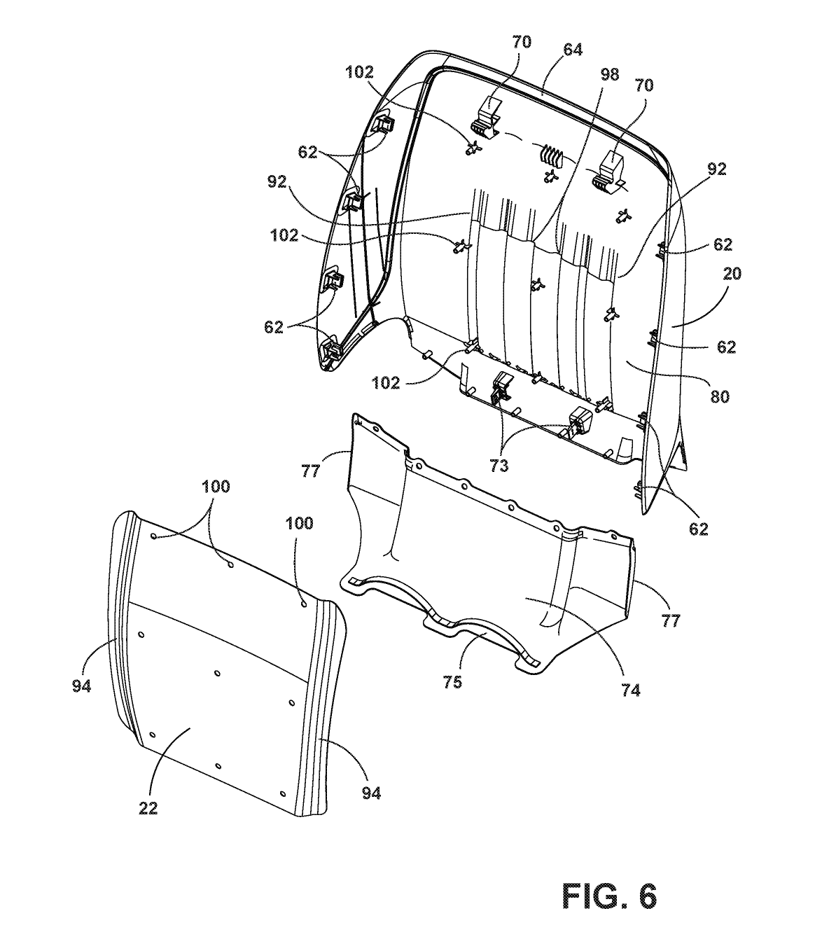

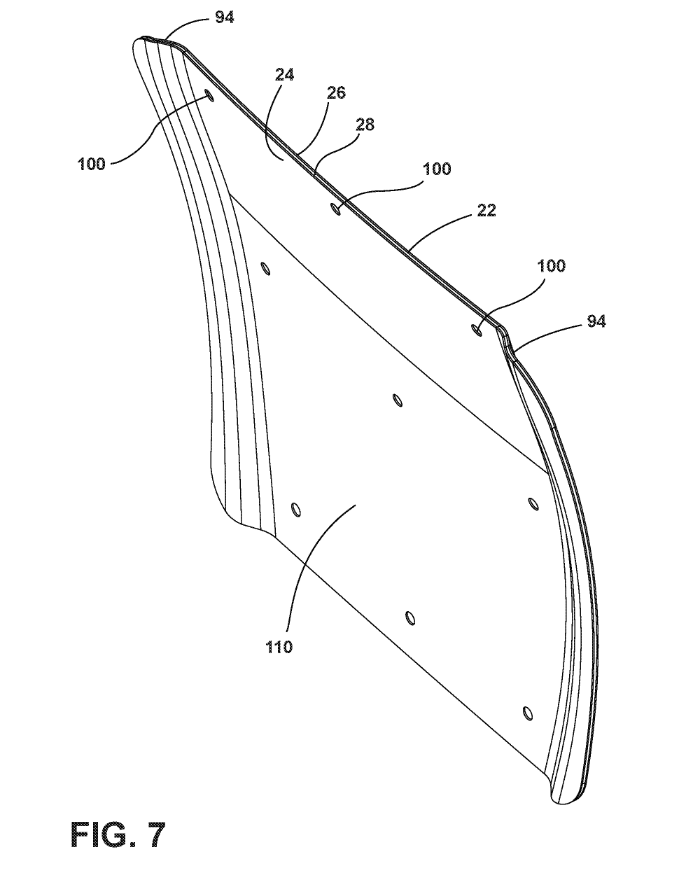

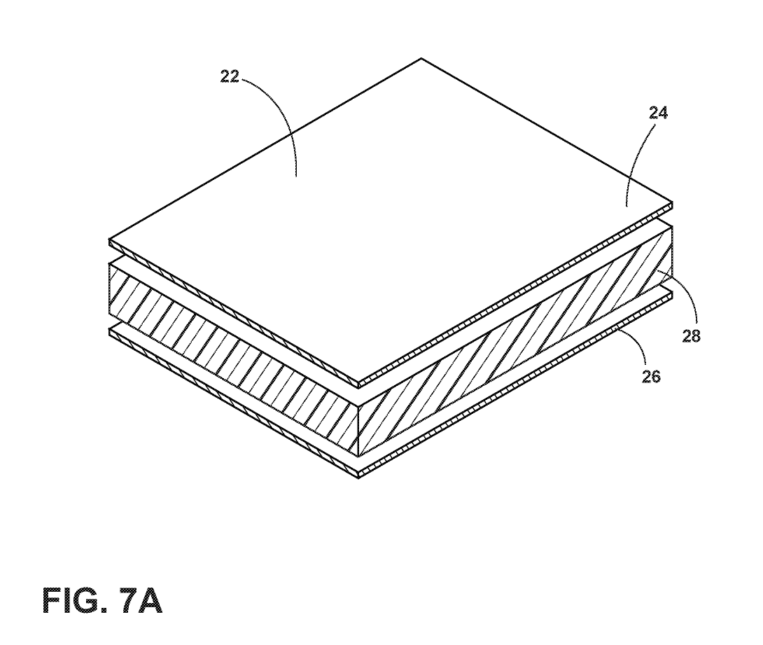

With reference now to FIGS. 6 and 7, the protective panel 22 includes a plurality of apertures 100 configured to receive fasteners, which may be heatstake bosses 102, that extend rearwardly from the interior surface 60 of the seatback panel 20. As previously noted, it will be understood that the connection of the protective panel 22 with the seatback panel 20 may be conducted in a variety of manners and is not limited to heatstaking. In addition, the protective panel 22 is configured to work in concert with the lower closeout panel 74 and is disposed above the lower closeout panel 74 after assembly.

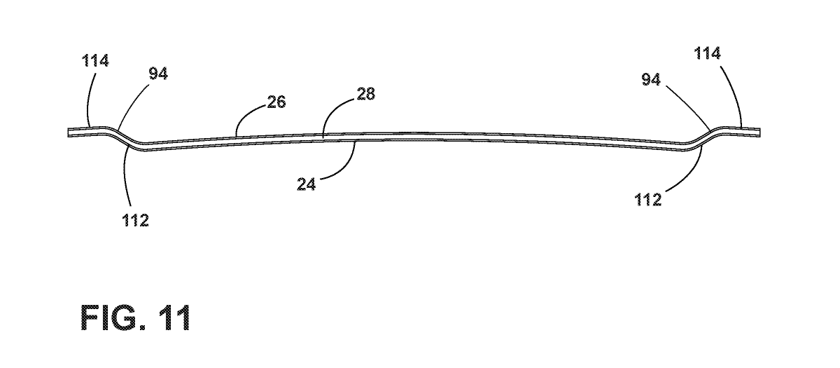

As can be seen in FIG. 7, the protective panel 22 includes a three-dimensional shape that provides protection to the intermediate portion of the seatback 14. A central portion 110 of the protective panel 22 includes a slightly arcuate configuration (see FIG. 11) configured to abut or be adjacent to the undulations 98 of the seatback panel 20 (FIG. 5). In addition, the offsets 94, which include an angled portion 112 and a side portion 114, help increase the structural rigidity of the protective panel 22 as a whole. As previously noted, the offsets 94 help locate the central portion 110 proximate a central area of the seatback panel 20 before the protective panel 22 is secured with the interior surface 60 of the seatback panel 20. This central area is protected because when a user is seated on the seating assembly 10, the central area is positioned adjacent internal organs of the seated passenger. Not only does the protective panel 22 include a three-dimensional shape, the protective panel 22 also includes a tri-composite construction. This tri-composite construction includes the polymeric material 28 disposed between first and second aluminum layers 24, 26. The polymeric material 28 may be any of a variety of materials, including Kevlar™, glass, or fibers that may be woven or non-woven and intermixed through the polymeric material 28. Glass beads may be utilized to lighten the weight of a matrix of the polymeric material 28. The polymeric material 28 is disposed between the two layers constructed of the first and second aluminum layers 24, 26. The first and second aluminum layers 24, 26 may vary in thickness, but are generally contemplated to be approximately 0.24 mm thick in one working embodiment, while the polymeric material 28 may be 1.92 mm thick. In one working example, the polymeric material 28 is a high crystalline polypropylene that is laminated between two sheets of ENAU-5182 aluminum. It is generally contemplated that the aluminum sheet may be as great at 3 mm thick, or less than 0.2 mm thick. In addition, it is contemplated that the polymeric material 28 may be greater than 10 mm thick, or less than 0.2 mm thick. The thickness of the materials may largely depend on the type of polymeric material 28 that is utilized and the particular application. Different sizes and thicknesses of the protective panel 22 and the components of the protective panel 22 may vary, depending on the particular application. As previously noted, the polymeric material 28 may be filled with any number of reinforcing materials, including glass, Kevlar , carbon fiber, natural fiber, talc, and mineral fillers. In addition, the glass beads may be utilized to produce an isotactic foam in the polymeric material 28 to further reduce weight. It is also contemplated that the thickness of the two sheets of aluminum may vary. For example, the aluminum sheet proximate the inside of the seating assembly 10 may be thicker as this is the last layer through which standing protection would be afforded.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or moveable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A seating assembly comprising:
a seat base; and
a seatback operably coupled to the seat base and including a seat cushion disposed on a front side thereof; and
a seatback panel includes a protective panel operably coupled therewith, the protective panel includes:
an internal aluminum panel disposed inside the seatback;
an external aluminum panel disposed on the seatback; and
a polymeric matrix disposed between the internal aluminum panel and the external aluminum panel.

2. The seating assembly of claim 1, wherein the polymeric matrix includes a reinforcing material disposed therein.

3. The seating assembly of claim 2, wherein the reinforcing material includes at least one of glass, Kevlar®, carbon fiber, natural fiber, talc, and a mineral filler.

4. The seating assembly of claim 1, wherein the polymeric matrix includes glass beads that define an isotactic foam in the polymeric matrix.

5. The seating assembly of claim 1, wherein the polymeric matrix is comprised of a high crystalline polypropylene.

6. The seating assembly of claim 1, wherein the polymeric matrix is heatstaked to each of the internal and external aluminum panels.

7. The seating assembly of claim 1, wherein the protective panel includes an offset disposed on at least one side of the protective panel.

8. A seating assembly comprising:
a seat base;
a seatback operably coupled to the seat base; and
a protective panel operably coupled with an inside surface of the seatback and including:
an internal panel disposed inside the seatback;
an external panel disposed on the seatback, wherein the internal and external panels are formed from one of a metal and metalloid material; and
a polymeric matrix disposed between the internal and external panels.

9. The seating assembly of claim 8, wherein the protective panel includes a plurality of apertures to receive fasteners extending from the seatback.

10. The seating assembly of claim 8, wherein the polymeric matrix includes a reinforcing material disposed therein.

11. The seating assembly of claim 10, wherein the reinforcing material includes at least one of glass, Kevlar®, carbon fiber, natural fiber, talc, and a mineral filler.

12. The seating assembly of claim 8, wherein the polymeric matrix includes glass beads that define an isotactic foam in the polymeric matrix.

13. The seating assembly of claim 8, wherein the polymeric matrix is comprised of a high crystalline polypropylene.

14. The seating assembly of claim 8, wherein the polymeric matrix is heatstaked to each of the internal and external aluminum panels.

15. A seatback for a vehicle seating assembly comprising:
a frame including first and second side frame members; and
a seatback panel having a protective panel disposed on a backside of the frame, the protective panel including:
an internal panel disposed inside the seatback;
an external panel disposed on the seatback, wherein the internal and external panels are formed from a metalloid material; and
a polymeric matrix disposed between the internal and external panels.

16. The seatback of claim 15, wherein the protective panel includes an offset disposed on at least one side of the protective panel.

17. The seatback of claim 16, further including:
a reinforcing material that includes at least one of glass, Kevlar®, carbon fiber, natural fiber, talc, and a mineral filler.

18. The seatback of claim 15, wherein the polymeric matrix includes glass beads that define an isotactic foam in the polymeric matrix.

19. The seatback of claim 15, wherein the polymeric matrix is comprised of a high crystalline polypropylene.

20. The seatback of claim 15, wherein the polymeric matrix includes a thickness that is greater than a thickness of the internal panel and a thickness of the external panel.
